(19) United States
(12) Patent Application Publication
(10) Pub. No.: US 2016/0021033 A1
(43) Pub. Date: Jan. 21, 2016

(54) TEMPORAL MESSAGE ORDERING

(71) Applicant: LENOVO (Singapore) PTE, LTD., New Tech Park (SG)

(72) Inventors: Nathan J. Peterson, Durham, NC (US); Bryan L. Young, Apex, NC (US); Amy Leigh Rose, Chapel Hill, NC (US); John Scott Crowe, Durham, NC (US); Jennifer Lee-Baron, Morrisville, NC (US)

(21) Appl. No.: 14/334,412

(22) Filed: Jul. 17, 2014

(51) Int. Cl. H04L 12/58; H04L 29/08

(52) U.S. Cl. CPC H04L 51/04; H04L 51/26; H04L 67/10

(57) ABSTRACT

For temporal message ordering, a method is disclosed that includes receiving an inbound text message from one or more remote devices, transmitting an entered outbound text message, and ordering the inbound text message and the outbound text message based on an order wherein the outbound text message is ordered before the inbound text message based on the inbound text message having a reception time after an entry start time for the outbound text message.

### BACKGROUND

1. Field

The subject matter disclosed herein relates to electronic communication and more particularly relates to temporal message ordering.

2. Description of the Related Art

Text based messaging is prevalent in modern society. Cellular devices, mobile devices, or other computing devices may support text based messaging to and/or from other computing devices.

Text based messages are typically displayed in a temporal order based on when the respective text messages were received.

### BRIEF SUMMARY

An apparatus for temporal message ordering is disclosed. In one embodiment the apparatus includes a processor and a memory that stores code executable by the processor. In one embodiment, the code includes code that receives an inbound text message from one or more remote devices. The code further includes code that transmits an entered outbound text message. In addition, the code includes code that orders the inbound text message and the outbound text message based on an order wherein the outbound text message is ordered before the inbound text message with a reception time after an entry start time for the outbound text message. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an apparatus for temporal message ordering;

FIG. 2 is a diagram illustrating one example of temporal message ordering;

FIG. 3 is a diagram illustrating one example of temporal message ordering;

FIG. 4 is an illustration depicting one example of a display screen displaying temporal message ordering;

FIG. 5 is a diagram illustrating one example of temporal message ordering;

FIG. 6 is a schematic flow chart diagram illustrating one embodiment of a temporal message ordering method;

FIG. 7 is a schematic flow chart diagram illustrating one embodiment of a temporal message ordering method; and

FIG. 8 is a schematic flow chart diagram illustrating one embodiment of a temporal message ordering method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

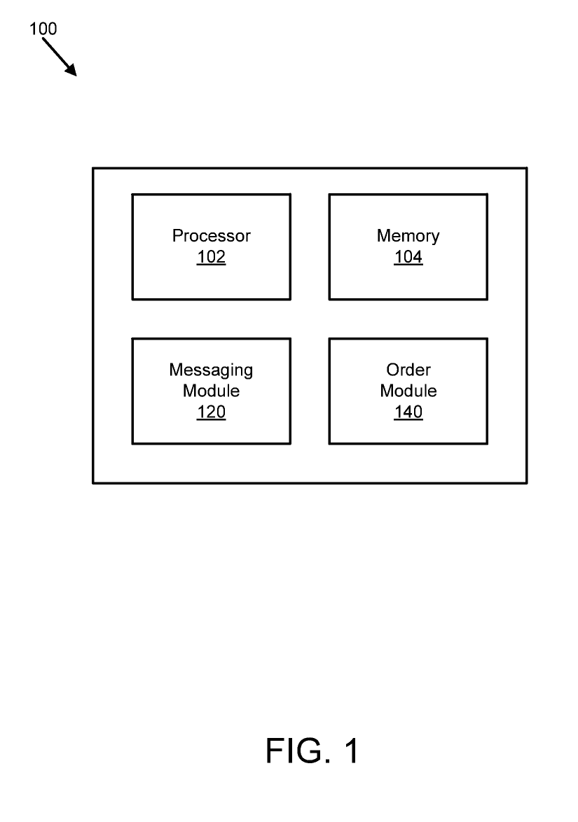

FIG. 1 is a schematic block diagram illustrating one embodiment of an apparatus for temporal message ordering. In one embodiment, the apparatus 100 includes a processor 102 and a memory 104 that stores code executable by the processor 102. The processor 102 may be any processor capable of executing executable code as one skilled in the art may appreciate. The memory 104 may be any memory storage device that is capable of storing executable code. The memory 104 may be volatile, non-volatile, solid state, magnetic, optical, or other, or the like as one skilled in the art may appreciate.

In one embodiment, the code may include a messaging module 120 that receives an inbound text message from one or more remote devices. An inbound text message may include any text message received or receivable by the messaging module 120. Text messages, as described herein, may include any message transmitted from one computing device to another computing device. In one example, the text message may be an SMS message. In another example, the text message may include an image, picture, or other, or the like. In another example, the text message may include a coded representation, such as, but not limited to Unicode, or other, or the like. In other examples, the text message may include a byte stream, a stream of characters. Therefore, a text message, as described herein, may represent any electronic information or data as one skilled in the art may appreciate.

In one embodiment, the messaging module 120 may transmit one or more outbound text messages entered by a user. In one example, the messaging module 120 may receive an audio signal comprising voice from a user, and may generate a text message representing spoken language by the user. In another example, the messaging module 120 may receive a text message via an input device, such as, but not limited to, a physical keyboard, a virtual keyboard, a numeric keypad, Morse code, or other, or the like as one skilled in the art may appreciate. The messaging module 120 may transmit an outbound text message received from a user to a remote device, a remote server, or any other computing device capable of receiving the message.

In another embodiment, the order module 140 may include code that orders the inbound text messages and outbound text messages based on a temporal order, the inbound text messages ordered based on a reception time and the outbound text messages ordered based on a time when the user began entering the text message.

In one embodiment, a user of the apparatus 100 may begin entering an outbound text message. The apparatus 100 may receive an inbound text message from a remote computing device after the user began entering the outbound text message. The order module may order the inbound text message and the outbound text message by ordering the outbound text message to be before the inbound text message because the inbound text message had been received after the user began entering the outbound text message.

In one embodiment, the order module 140 may order many received inbound messages in an order based on when the inbound messages were received. In another embodiment, the inbound messages may include time stamps when the inbound messages were transmitted and the order module 140 may order the inbound messages based on the time included in the respective inbound messages. Therefore, in certain embodiments, the inbound messages may be temporally organized based on a time value, stamp, index, or the like.

In another embodiment, the order module 140 may order one or more outbound messages to be transmitted based on when a user began typing the outbound message. In one example, a user may begin typing outbound message A, and may subsequently begin typing outbound message B (without necessarily finishing outbound message A). If the user finishing typing outbound message B before message A, the order module 140 may place outbound message B in an order before outbound message A.

The order module 140 may order the messages by putting messages in an ordered list, ordered set, an array, vector, or other, or the like. Of course, one skilled in the art may recognize a wide variety of different ways a set of messages may be stored in an order, and the order module 140 is meant to include all such ways.

In one embodiment, the order module 140 may combine inbound messages and outbound messages into a single ordered list of messages. In one example, the messaging module 120 may receive a first inbound text message A at time index 10010. The messaging module 120 may begin composition of another outbound message B, based on user input, at time index 10020. The messaging module 120 may receive a second inbound text message C at time index 10030. The messaging module 120 may transmit the outbound message B at time index 10040. Because the messaging module may have begun composition of outbound message B before receiving inbound message C, the order module 140 may order the messages in the order A, B, C. This may be the case although inbound message C may have been received before outbound message B has been completed, transmitted, or the like.

In another embodiment, the order module 140 may display the messages being received and/or transmitted. In one example, the messaging module 120 may receive a first inbound text message A at time index 10010 and the order module 140 may display the message A. The messaging module 120 may begin composition of an outbound message B, based on user input, at time index 10020, and the order module 140 may display the message B as it is being composed. The messaging module 120 may receive a second inbound text message C at time index 10030 and the order module 140 may not immediately display the second inbound text message C. The messaging module 120 may transmit the outbound message B at time index 10040 and the order module 140 may display the outbound message B. In response to transmitted outbound message B, the order module may display inbound message C (after outbound message B). Therefore, in this example, the messages may be displayed in the order A, B, C. This may be the case although inbound message C may have been received before outbound message B has been completed, transmitted, or the like.

In another example, while the messaging module 120 may be composing outbound message B, the messaging module 120 may receive many more inbound messages. The order module 140 may delay displaying the inbound messages until the outbound message B is completed. In another example, the order module 140 may delay displaying the inbound message until a timeout threshold value is reached. For example, the messaging module 120 may abandon an outbound message being composed after a 1 minute time interval where there is no input from a user. Therefore, in certain embodiments, the order module 140 may delay displaying received inbound messages until after a time out value. In response to the timeout value being exceeded, the order module 140 may display additional inbound messages.

In another embodiment, in response to the messaging module 120 receiving input from a user, the order module 140 may reset the timeout value. Therefore, as long as a user is entering text, the order module 140 may delay displaying inbound messages. In one embodiment, the order module 140 may store one or more configuration settings. For example, one configuration setting may indicate whether to delay displaying inbound messages while a user enters a text message. In another example, another configuration setting may indicate a timeout value to be used as previously described.

In another embodiment, the order module 140 may alter a color, or other property of a text message in order to indicate associations between text messages. In one example, the messaging module 120 may receive an inbound text message at time index 8880, the messaging module may subsequently begin composition of an outbound text message B at time index 8890. In response to no inbound text messages being received between message A and message B, the order module may associate message A and message B. In one example, the order module 140 may indicate that message B is a response to message A. In response to an association between messages, the order module may change a color of the associated messages. For example, the order module 140 may change associated message to blue, orange, green, purple, yellow, or other, or the like. Making associated messages a common color may better indicate to a user which messages are associated and/or which messages are responses to other messages.

In another embodiment, the order module 140 may transmit message associations to another remote device. For example, in response to making an association between message A and message B, the order module 140 may transmit the association to a remote device that transmitted message A. Therefore, the remote device, and/or an order module 140 operating at a remote device may also alter colors of various text messages based on the associations.

In another embodiment, an order module 140 operating at a remote device transmitting message A, may indicate a color or number to be used for message that may be associated with the message A at a local order module 140. For example, an order module 140 operating at a remote device, may transmit an inbound message A to a local order module 140 and may indicate that the color for associations is the color blue. In response to the local order module 140 making associations with message A at the local computing device, the order module 140 may change a background color for the associated inbound messages to blue.

In another example, an order module 140 operating at a remote device, may transmit an inbound message A to a local order module 140 and may indicate that the numeric value for associations is the number 98765. In response to the local order module 140 making associations with inbound message A at the local computing device, the order module 140 may change a numeric value for the associated messages to the number 98765.

In another embodiment, the order module 140 may display inbound messages below or under an outbound message being composed. Displaying additional inbound messages below or under a message being composed may more accurately depict an order for messages as described herein.

In one embodiment, the order module 140 may transmit an order of one or more messages to a remote device that may have transmitted one or more of the inbound messages. Therefore, in certain embodiments, a transmitter of inbound messages, and a receiver of inbound messages may synchronize an order for the inbound messages.

In another embodiment, the order module 140 may reorder messages in a list of messages based on a temporal order of another computing device. In one example, a temporal order of messages at one computing device may not consistent with a temporal order of messages at another computing device. Therefore, in one example, an order module 140 operating at an apparatus A may transmit an order of messages to an order module 140 operating at an apparatus B. In response to receiving the order of messages, the order module 140 operating at apparatus B may alter an order of messages.

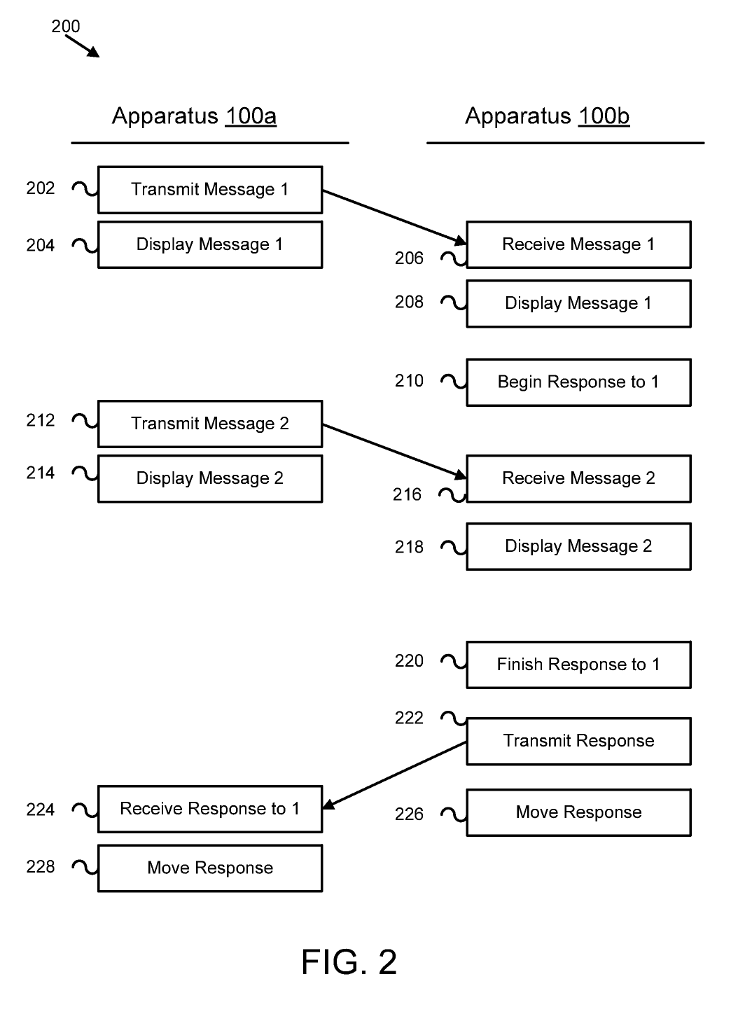

FIG. 2 is a diagram illustrating one example of temporal message ordering. In one example, a first apparatus 100a may transmit one or more messages to a second apparatus 100b. In one example, the apparatus 100a may transmit 202 a message 1 to apparatus 100b and may display 204 the message 1. The apparatus 100b may receive 206 the message 1 and may display 208 message 1. The apparatus 100b may begin composition 210 of a response to message 1. Thereafter, the apparatus 100a may transmit 212 a message 2 to apparatus 100ba and may display 214 message 2. The apparatus 100b may receive 216 message 2 and may display 218 message 2.

The apparatus 100b may thereafter finish 220 the response to message 1 and may transmit 222 the response to apparatus 100a. The apparatus 100a may receive 224 the response to message 1. The apparatus 100b may move 226 the response to message 1 to be before message 2 based on the response beginning before message 2 was received at apparatus 100b. The apparatus 100b may transmit a temporal order of messages to apparatus 100a, and the apparatus 100a may move the response to message 1 to be above or before the transmission time of message 2 based on the temporal order at apparatus 100b.

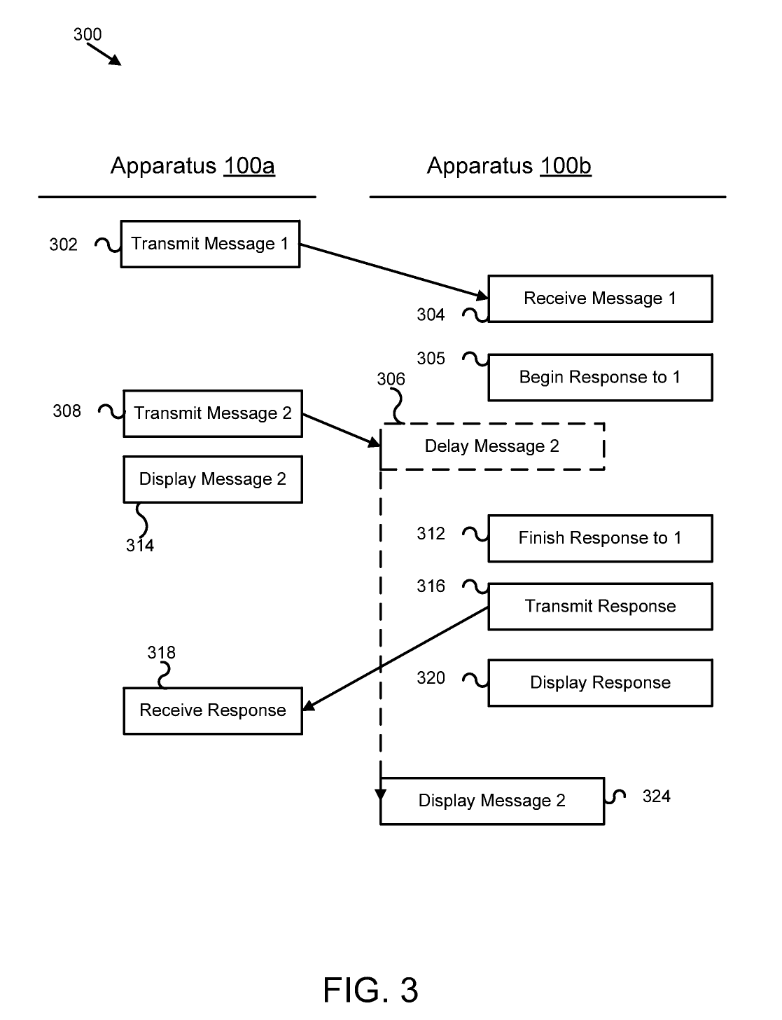

FIG. 3 is a diagram illustrating one example of temporal message ordering. Apparatuses 100a and 100b may or may not be substantially similar to those depicted in FIG. 2. In one example, a messaging module 120a operating at an apparatus 100a may transmit 302 a message 1 to a messaging module 120b operating at apparatus 100b. The apparatus 100b may receive 304 the message 1 and may subsequently begin 305 a response to message 1. The apparatus 100a may transmit 308 a message 2 to apparatus 100b. The apparatus 100b may delay 306 message 2 in response to the messaging module 120b composing the response to message 1 before the apparatus 100b received message 2.

The messaging module 120b operating at apparatus 100b may finish 312 the response to message 1, may transmit 316 the response to apparatus 100a, and may display 320 the response to message 1. The apparatus 100a may receive 318 the response to message 1. The apparatus 100b may thereafter display 324 delayed message 2, such that message 2 is later in an order of messages than the response to message 1. This may be the case although message 2 was transmitted by apparatus 100a before apparatus 100b completed composition of the response to message 1.

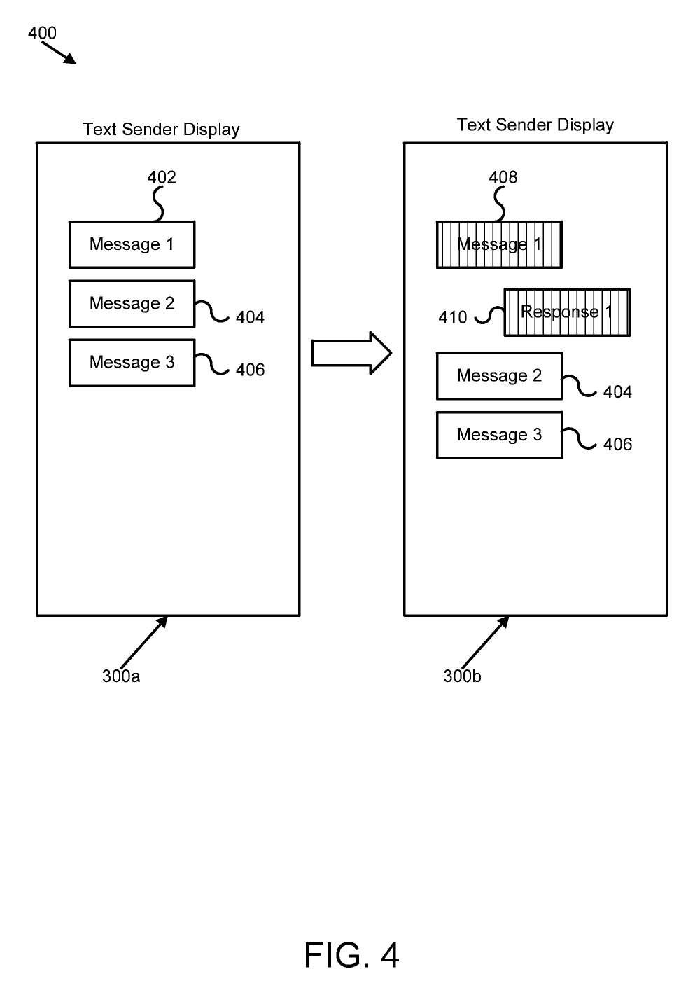

FIG. 4 is an illustration depicting one example of a display screen displaying temporal message ordering. In one example, an apparatus 100 may include a messaging module 120 that transmits one or more outbound text messages. The display 300a may depict one example of a display for the apparatus 100 that displays the transmitted outbound messages. In this example, the messaging module 120 may display outbound messages 1 402, 2 404, and 3 406. At a remote device (not depicted in FIG. 4) that may receive the messages, a user may begin a response to outbound message 1. The remote device may receive messages 2 and 3 before completing the inbound text message response. A messaging module 120 operating at the remote device of messages may associate the inbound text message response with message 1 and may subsequently transmit the inbound response 410 and the association to the apparatus 100. In response to receiving the inbound response 410, the apparatus 100 may alter a display 300b of messages and may display the inbound response 410 in a temporal order based on when the response was initiated at the remote device (not depicted in FIG. 4). Therefore, in this example, the messaging module 120 operating at the apparatus 100, may display the inbound response 410 in the order, as depicted in display 300b. Furthermore, the order module 140 may indicate the association by altering a display property for the messages that are associated. In the depicted display 300b, the order module 140 may alter a color for the message 1, change a background color or pattern for the message and the associated response 410. This may allow a user to more easily determine for which outbound message the inbound response 410 is intended.

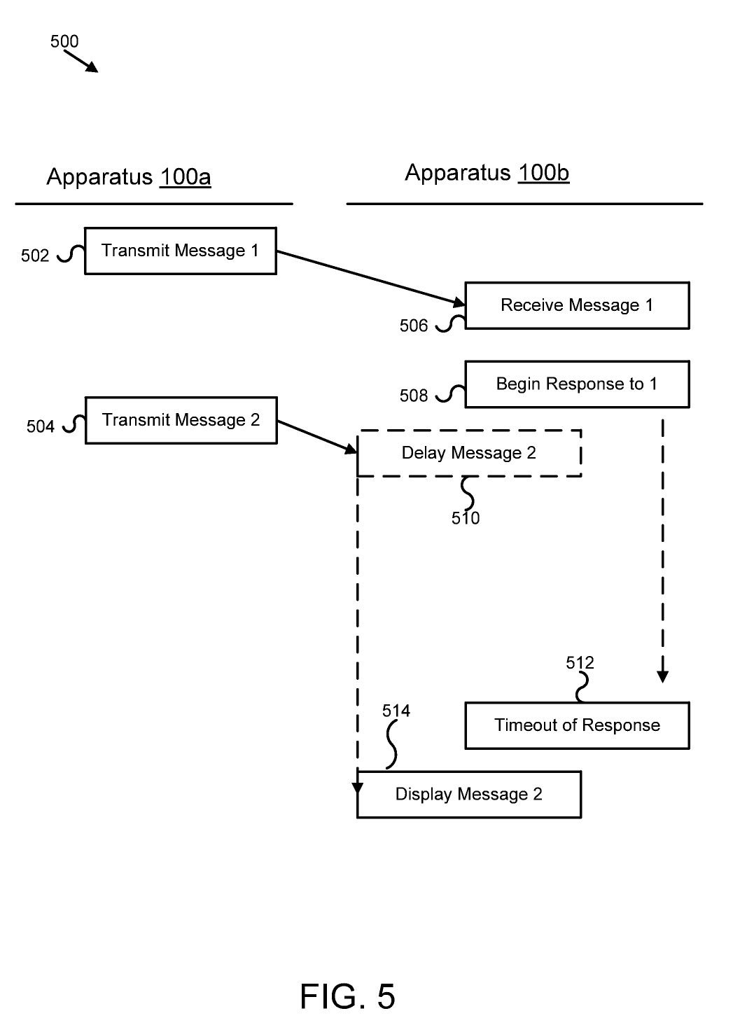

FIG. 5 is a diagram illustrating one example of temporal message ordering. In one example, the apparatus 100a may transmit 502 a message 1 to apparatus 100b. Apparatus 100a and 100b may include respective messaging modules 120 and respective order modules 140. Therefore, as apparatuses 100 are described to perform message receiving and transmitting, the receiving and transmitting may be performed by respective messaging modules 120 operating at the apparatuses 100.

The apparatus 100b may receive 506 message 1 and may begin 508 a response to message 1. Before, after, or at the same time as the apparatus 100b begins 508 a response to message 1, the apparatus 100a may transmit 504 message 2. The apparatus may receive message 2 after beginning 508 the response to message 1 and may delay 510 displaying message 2. A user may cease entering the response to message 1, and the messaging module 120 may timeout. In response to timing out, the order module 140 may display 514 the received message 2.

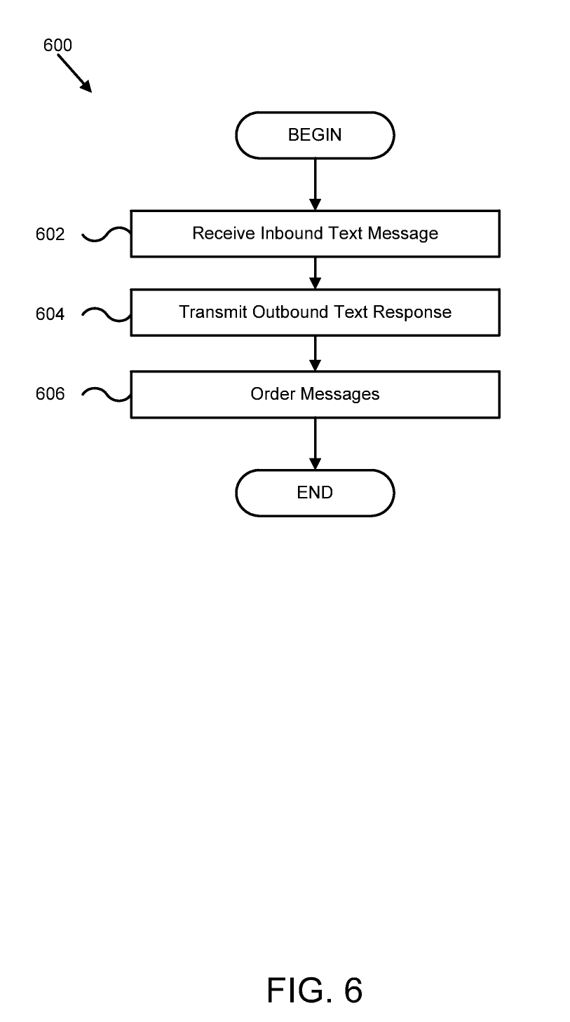

FIG. 6 is a schematic flow chart diagram illustrating one embodiment of a temporal message ordering method. In one embodiment, the method 600 may begin and a messaging module 120 may receive 602 one or more inbound text based messages from one or more remote devices. The messaging module 120 may transmit one or more outbound text messages. In some embodiments, the transmitted outbound text message may be responses to the received inbound text messages. The order module 140 may order the received inbound messages and the transmitted outbound messages by ordering the received inbound messages based on a time when the inbound messages were received and ordering the transmitted outbound messages based on a time when a user began composing the outbound messages to be transmitted. The ordering module 140 may thereby multiplex received messages and transmitted messages into one ordered list of messages, based on an order described herein.

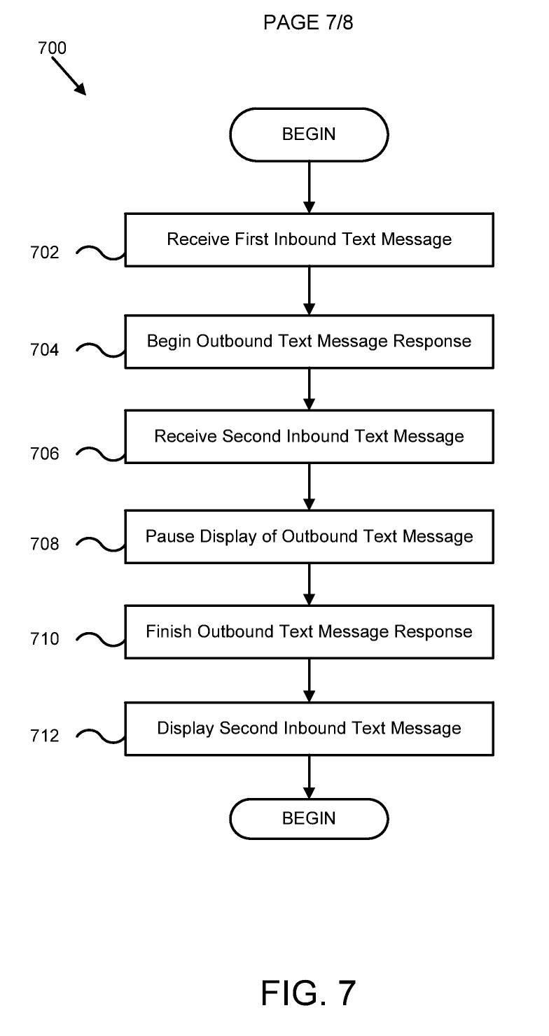

FIG. 7 is a schematic flow chart diagram illustrating one embodiment of a temporal message ordering method. In one embodiment, the method 700 may begin and the messaging module 120 may receive 702 one or more inbound text messages. The messaging module 120 may begin 704 a response to one or more of the received inbound text messages. The messaging module 120 may receive 706 a second inbound text message. In response to the messaging module composing an outbound text message response to the earlier first inbound text message, the messaging module 120 may pause 708 display of the outbound text message. Thereafter, the messaging module may finish 710 the outbound text message response that was started at block 704 and the order module 140 may display 712 the second inbound text message.

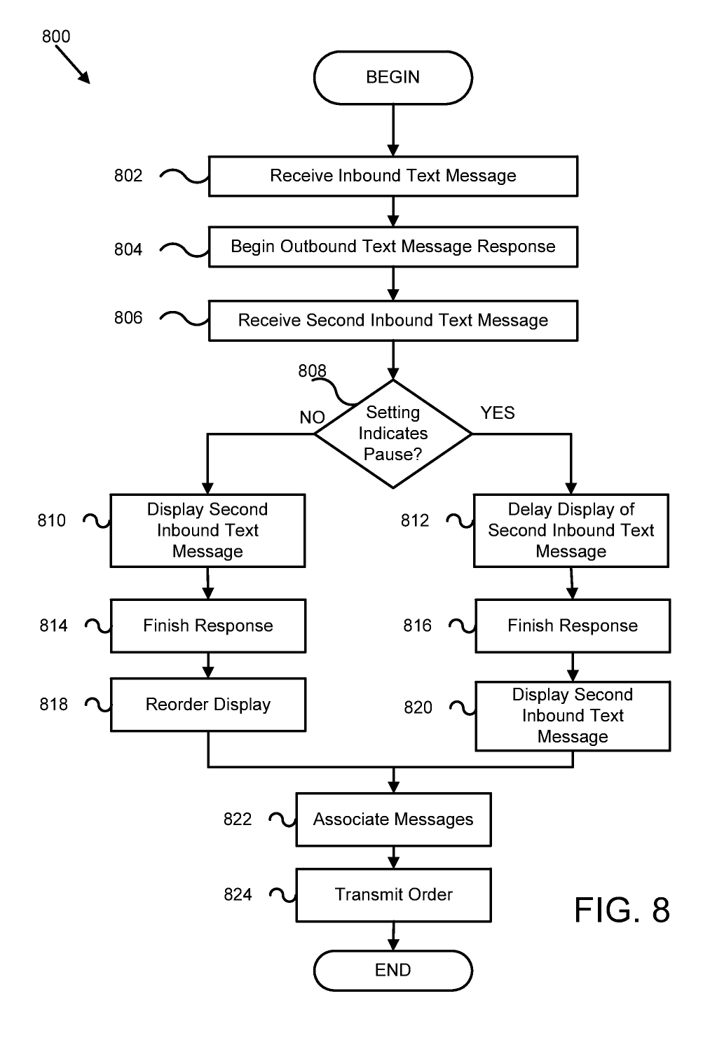

FIG. 8 is a schematic flow chart diagram illustrating one embodiment of a temporal message ordering method. In one embodiment, the method 800 may begin and the messaging module 120 may receive 802 one or more inbound text messages from a remote device. The messaging module 120 may begin 804 an outbound text message response to one of the received text messages. The messaging module 120 may thereafter receive 806 a second inbound text message. The order module 140 may determine 808 whether a configuration setting indicates to pause displaying inbound messages while a user enters a text message.

In response to the configuration setting indicating to pause, the messaging module 120 may delay 812 displaying the second inbound text message. The messaging module 120 may finish 816 the outbound text message response and the order module 140 may thereafter display 820 the second inbound text message.

In response to the configuration setting indicating not to pause, the messaging module may display 810 the second inbound text message. The messaging module 120 may complete 814 composition of the outbound text message response. The order module 140 may reorder 818 displayed text messages in the order as described herein. In this example, the order module 140 may move the completed outbound text message response to be above or ahead of the second inbound text message and subsequent to the first inbound text message. The order module 140 may associate 822 the second inbound text message with the response and may transmit 824 the one or more message associations to a remote device. In one example, the remote device may include the remote device that transmitted the first inbound text message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor, the code comprising:
code that receives an inbound text message from one or more remote devices;
code that transmits an entered outbound text message; and
code that orders the inbound text message and the outbound text message based on an order wherein the outbound text message is ordered before the inbound text message based on the inbound text message having a reception time after an entry start time for the outbound text message.

2. The apparatus of claim 1, the code further comprising code that displays the inbound text message and the outbound text message in the order.

3. The apparatus of claim 2, wherein the code delays displaying the inbound text message in response to the user entering the outbound text message.

4. The apparatus of claim 3, wherein the delay times out, based on a user not entering text for a threshold amount of time.

5. The apparatus of claim 3, wherein the code delays displaying based on a configuration setting.

6. The apparatus of claim 1, the code further transmits the order to one of the remote devices.

7. The apparatus of claim 1, the code further associates temporally contiguous text messages using an indicator selected from the group consisting of colors, characters, and numbers.

8. A method comprising:
receiving, by use of a processor, an inbound text message from one or more remote devices;
transmitting an entered outbound text message; and
ordering the inbound text message and the outbound text message based on an order wherein the outbound text message is ordered before the inbound text message based on the inbound text message having a reception time after an entry start time for the outbound text message.

9. The method of claim 8, further comprising displaying the inbound text message and the outbound text message in the order.

10. The method of claim 9, wherein displaying the inbound text message is delayed in response to a user entering the outbound text message.

11. The method of claim 10, wherein the delaying times out based on a user not entering text for a threshold amount of time.

12. The method of claim 10, where the delaying is based on a configuration setting.

13. The method of claim 8, further comprising transmitting the order to one of the remote devices.

14. The method of claim 8, further comprising associating temporally contiguous text messages using an indicator selected from the group consisting of colors, characters, and numbers.

15. A program product comprising a computer readable storage medium that stores code executable by a processor, the executable code comprising code to perform:
receiving an inbound text message;
transmitting an entered outbound text message; and
ordering the inbound text message and the outbound text message based on an order wherein the outbound text message is ordered before the inbound text message based on the inbound text message having a reception time after an entry start time for the outbound text message.

16. The program product of claim 15, the code further displaying the inbound text message and the outbound text message in the order.

17. The program product of claim 16, wherein the code delays displaying the inbound text message in response to a user entering the outbound text message.

18. The program product of claim 17, wherein the delay times out based on a user not entering text for a threshold amount of time.

19. The program product of claim 17, wherein the delay is based on a configuration setting.

20. The program product of claim 15, the code further associating temporally contiguous text messages using an indicator selected from the group consisting of colors, characters, and numbers.
